(19) United States
(12) Patent Application Publication
(10) Pub. No.: US 2017/0129319 A1
(43) Pub. Date: May 11, 2017

(54) Truck Cover Apparatus

(71) Applicant: Pedro Ayala-Rosado, San Antonio, TX (US)

(72) Inventor: Pedro Ayala-Rosado, San Antonio, TX (US)

(21) Appl. No.: 15/234,965

(22) Filed: Aug. 11, 2016

Related U.S. Application Data
(60) Provisional application No. 62/203,583, filed on Aug. 11, 2015.

(51) Int. Cl. B60J 11/00; A01M 31/02

(52) U.S. Cl. CPC B60J 11/00; A01M 31/025

(57) ABSTRACT

A truck cover apparatus for covering a pickup truck is provided. The pickup truck has a cab and a bed with the cab having a driver's side door and a passenger door and the bed having a tailgate. The truck cover apparatus comprises a cover and a first and second zippered panel formed in the cover. The first zippered panel is positioned over a door of the cab and the second zippered panel is positioned over the bed. A first zipper mechanism is associated with the first zippered panel and a second zipper mechanism is associated with the second zippered panel. Upon unzipping the first zipper mechanism, the first zippered panel opens so that the door of the cab can be opened allowing access to the cab of the truck and upon unzipping the second zipper mechanism, the second zippered panel opens allowing access to the bed of the truck.

### CLAIM OF PRIORITY

This patent application claims priority under 35 USC 119 (e) (1) from U.S. Provisional Patent Application Ser. No. 62/203,583 filed Aug. 11, 2015, of common inventorship herewith entitled, “Camouflage Truck Cover With Zipper Access,” which is incorporated herein by reference as though the same were set forth in its entirety.

### FIELD OF THE INVENTION

The present invention pertains to the field of auto accessories, and more specifically to the field of auto covers.

### BACKGROUND OF THE INVENTION

Hunters go to a great deal of time, trouble, effort and expense to outfit themselves for successful hunting. Few things are more important to a successful hunt than credible concealment and camouflage. And in the field, few things are more glaringly unconcealed than a bright shiny pickup truck. While a truck is the best way to get to and from the hunt, a shiny metallic truck is certain to scare away any wild game that sees it. A hunter can park a considerable distance from hunting grounds, or a hunter can park closer to the hunting grounds and attempt to disguise the truck.

The prior art has put forth several designs for auto covers. Among these are:

US Patent 2013/0087178 to Richard Andrew Atherton describes a portable hunting or wildlife observation structure that fits to the bed of most pickup trucks. All components of the structure are stored inside a lockable storage case, which also acts as a bed width, adjustable bench seat for the user when the structure is assembled. The structure's five sided structure incorporates height adjustable shooting bars and a roof structure. A weatherproof camouflage material provides a surround and roof cover for the structure. Separate weatherproof camouflage material is magnetically attached to conceal the truck.

U.S. Pat. No. 6,302,469 to Samuel H. Jones describes a reversible soft cover for trucks or other vehicles. The cover contains a central upper portion, and front, rear and side portions extending from the central portion to completely enclose a bed or cargo area. Each of the front, rear and side portions are individually openable, and the rear section is rolled up from inside or outside the vehicle using a lanyard. Flap covers prevent the hemmed side edges of the front, rear and side portions from exposure, regardless of which surface is exposed, and provide a substantially weatherproof seal between panels.

U.S. Pat. No. 6,017,079 to Joseph Warner describes a kit for outfitting the exterior surface of a vehicle. The kit is made up of a plurality of pressure sensitive, adhesive backed, camouflage panels. Each of the panels adhere to a specific segment of the vehicle surface. The panels preferably include marginal strips that permit the panels to register with their associated segments of the vehicle. These marginal strips also provide panel overlap portions to ensure complete surface coverage by the panels.

U.S. Pat. No. 5,549,938 to Gregg G. Nesbitt describes a removable camouflage primarily for hunting and military vehicles. The removable camouflage is characterized in a first preferred embodiment by a flexible, elastomeric magnetic panel having a selected camouflage pattern provided thereon. The camouflage panel magnetically attaches to a steel surface such as the panels of a truck or other vehicle to facilitate quick and easy camouflaging of the vehicle without damaging or altering the paint on the vehicle. In another preferred embodiment the removable camouflage includes multiple, irregularly shaped camouflage plates, also constructed of a magnetic material having a selected camouflage pattern thereon and capable of being attached to the steel surfaces of a vehicle to camouflage the vehicle. The camouflage pattern is imprinted on the flexible magnetic material itself or on a vinyl overlay laminated on the flexible magnetic material.

None of these prior art references describe the present invention.

### SUMMARY OF THE INVENTION

It is an object of the present invention to provide a full length, camouflage cover for pickups that provides a hunter with realistic looking concealment from their quarry and allows the hunter to park close to a hunting site.

The present invention is a truck cover apparatus for covering a pickup truck. The pickup truck has a cab and a bed with the cab having at least a driver's side door and a passenger door and the bed having a tailgate. The truck cover apparatus comprises a cover, a first zippered panel formed in the cover, and a second zippered panel formed in the cover. The first zippered panel is capable of being positioned over a door of the cab of the truck and the second zippered panel is capable of being positioned over the bed of the truck. A first zipper mechanism is associated with the first zippered panel and a second zipper mechanism is associated with the second zippered panel. Upon unzipping the first zipper mechanism, the first zippered panel is openable so that the door of the cab can be opened allowing access to the cab of the truck and upon unzipping the second zipper mechanism, the second zippered panel is openable allowing access to the bed of the truck.

In addition, the present invention includes a method for covering a pickup truck. The pickup truck has a cab and a bed with the cab having at least a driver's side door and a passenger door and the bed having a tailgate. The method comprises providing a cover, forming a first zippered panel formed in the cover, positioning the first zippered panel over a door of the cab of the truck, forming a second zippered panel formed in the cover, positioning the second zippered panel over the bed of the truck, associating a first zipper mechanism with the first zippered panel, associating a second zipper mechanism with the second zippered panel, unzipping the first zipper mechanism, opening the first zippered panel, allowing access to the cab of the truck, unzipping the second zipper mechanism, opening the second zippered panel, and allowing access to the bed of the truck.

The present invention further includes a truck cover apparatus for covering a pickup truck. The pickup truck has a cab and a bed with the cab having at least a driver's side door and a passenger door and the bed having a tailgate. The truck cover apparatus comprises a cover capable of completely covering the cab and the bed of the truck. A first zippered panel is formed in the cover with the first zippered panel capable of being positioned over a door of the cab of the truck. A second zippered panel is formed in the cover with the second zippered panel capable of being positioned over the bed of the truck. A third zippered panel is formed in the cover with the third zippered panel capable of being positioned over the tailgate of the bed of the truck. A first zipper mechanism is associated with the first zippered panel, a second zipper mechanism is associated with the second zippered panel, and a third zipper mechanism is associated with the third zippered panel. Upon unzipping the first zipper mechanism, the first zippered panel is openable so that the door of the cab can be opened allowing access to the cab of the truck. Upon unzipping the second zipper mechanism, the second zippered panel is openable allowing access to the bed of the truck. Upon unzipping the third zipper mechanism, the third zippered panel is openable so that the tailgate can be opened allowing access to the bed of the truck.

### BRIEF DESCRIPTION OF THE DRAWINGS

FIG. 1 is a perspective view illustrating a truck cover apparatus, constructed in accordance with the present invention, with the truck cover apparatus applied over a truck cab and bed.

FIG. 2 is a perspective view of the truck cover apparatus, constructed in accordance with the present invention, with the truck cover apparatus mounted on a truck, showing unzipped panels that provide access to the interior of the cab and the interior of the bed of the truck.

FIG. 3 is a top plan view of various camouflage patterns of the truck cover apparatus, constructed in accordance with the present invention.

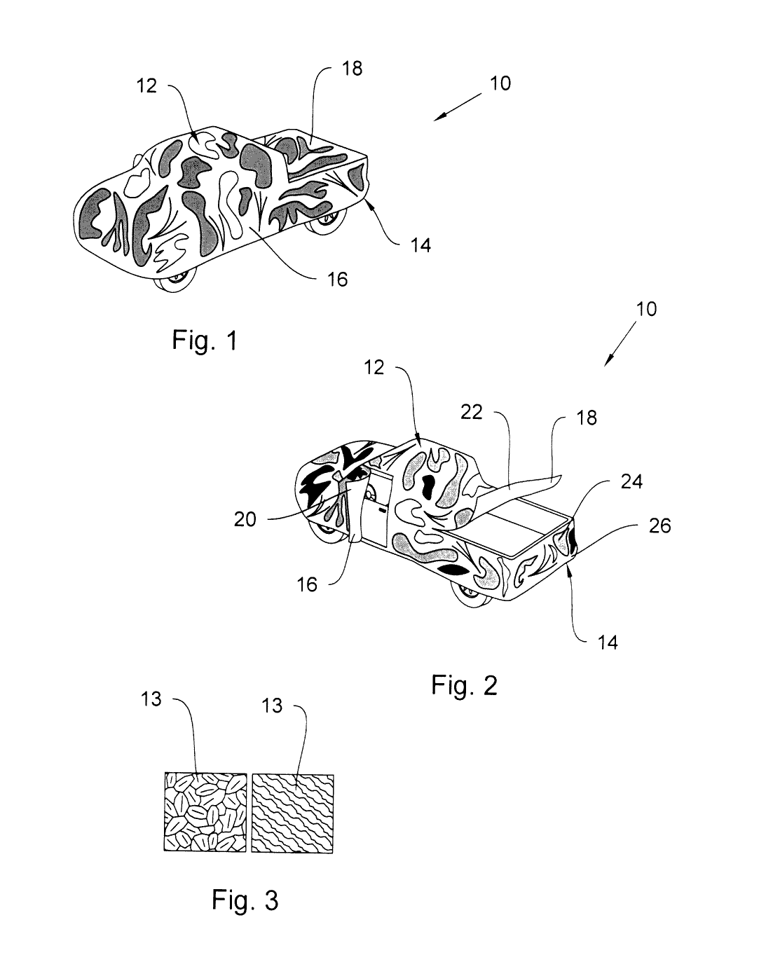

### DETAILED DESCRIPTION OF THE INVENTION

The present invention, hereinafter referred to as a Truck Cover Apparatus, indicated generally at 10, is a full camouflage cover 12 for pickup trucks 14. The Truck Cover Apparatus 10 of the present invention provides the hunter and outdoor enthusiast with realistic looking concealment from their quarry, and allows the hunter and outdoor enthusiast to park close to the hunting or viewing site. The Truck Cover Apparatus 10 provides hunters with a line of formfitting, full length, all weather pickup covers 12 that conceal and camouflage their truck 14 to look similar to woods.

The Truck Cover Apparatus 10 of the present invention includes a cover 12 for completely covering the cab and the bed of a truck 14. Preferably, the cover 12 does not extend all the way to the ground surface with at least a portion of the tires of the truck 14 being exposed thereby keeping the cover 12 free from soiling and damage from the ground surface. It should be noted that while it is preferable for the cover 12 to stop short of the ground surface, it is within the scope of the present invention for the cover 12 to extend completely to the ground surface thereby completely covering the cab, the bed, and the tires of the truck 14.

The cover 12 of the Truck Cover Device 10 of the present invention includes a first zippered panel 16 positioned over a door of the cab of the truck 14 and a second zippered panel 18 positioned over the bed of the truck 14. The first zippered panel 16 has a first zipper mechanism 20 allowing the first zippered panel 16 to be opened so that the door of the cab can be opened allowing access to the cab of the truck 14. The second zippered panel 18 has a second zipper mechanism 22 allowing the second zippered panel 18 to be opened allowing access to the bed of the truck 14. Opening the first zippered panel 16 and/or the second zippered panel 18, a hunter has easy access to the cab interior and the bed of the truck 14 without having to first remove the cover 12.

In a preferred embodiment, the first zippered panel 16 of the cover 12 of the Truck Cover Apparatus 10 of the present invention is positioned over the driver's door of the truck 14. It is within the scope of the present invention, however, for the first zippered panel 16 to be positioned over a different door, i.e., the passenger side door, or for there to be a zippered panel for more than one door or all doors of the cab of the truck 14.

In a preferred embodiment of the Truck Cover Apparatus 10 of the present invention, the cover 12 can also include a third zippered panel 24 positioned over the tailgate of the bed of the truck 14. The third zippered panel 24 has a third zipper mechanism 26 allowing the third zippered panel 24 to be opened so that the tailgate can be opened additional access to the bed of the truck 14.

Preferably, the first zipper mechanism 20, the second zipper mechanism 22, and the third zipper mechanism 26 of the Truck Cover Apparatus 10 of the present invention are constructed of a nylon material although constructing the first zipper mechanism 20, the second zipper mechanism 22, and the third zipper mechanism 26 from a different material is within the scope of the present invention.

Preferably, the Truck Cover Apparatus 10 of the present invention is produced in sizes corresponding to full sized pickup trucks, short bed pickup trucks, and compact pickup trucks. In addition, the cover 12 of the Truck Cover Apparatus 10 is preferably constructed from a high denier, synthetic polyester that is softly lined and smooth on the inside and waterproof, UV resistant, and mildew resistant on the outside. The outside surface of the cover 12 has a camouflage pattern imprint 13. The camouflage pattern 13 of the cover 12 of the Truck Cover Apparatus 10 is a standard universal pattern or a pattern specific to tree stand hunters, brush country hunters, bottomland hunters, or waterfowl hunters.

As stated, the Truck Cover Apparatus 10 of the present invention is equipped with heavy duty, nylon zippered access panels. The zippered panels are configured to fit two door and four door pickup trucks. The cover 12 of the Truck Cover Apparatus 10 folds or rolls up for being stored. Further, the cover 12 can accompanied by its own drawstring carry bag for easy storage and protection.

Using the Truck Cover Apparatus 10 of the present invention is simple and straightforward. A hunter selects the cover 12 of the present invention in, an appropriate camouflage pattern 13 for their hunting site and an appropriate size for their hunting truck. After arriving at their hunting site, the hunter unfolds the cover 12 of the Truck Cover Apparatus 10 and applies the over the entire truck. The truck 14 now blends in with the wooded area where it is parked. To unload or load needed gear and supplies, the hunter simply unzips the paneled areas over the truck's bed and doors to gain access to items in these areas. Upon returning to the truck 14 after hunting, the hunter removes the Truck Cover Apparatus 10, folds or rolls it up and stores it in a secure place within the truck 14.

The Truck Cover Apparatus 10 of the present invention enables hunters to park close to the hunting site and fully camouflage their trucks while retaining easy access to the interior of the truck 14. In addition to camouflaging a truck 14, the Truck Cover Apparatus 10 provides all weather protection for a truck 14, whether standing in the wild or in a family driveway. Durably and cleverly constructed of high quality material, the present invention will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A truck cover apparatus for covering a pickup truck, the pickup truck having a cab and a bed, the cab having at least a driver's side door and a passenger door, the bed having a tailgate, the truck cover apparatus comprising:
a cover;
a first zippered panel formed in the cover, the first zippered panel capable of being positioned over a door of the cab of the truck;
a second zippered panel formed in the cover, the second zippered panel capable of being positioned over the bed of the truck;
a first zipper mechanism associated with the first zippered panel; and
a second zipper mechanism associated with the second zippered panel;
wherein upon unzipping the first zipper mechanism, the first zippered panel is openable so that the door of the cab can be opened allowing access to the cab of the truck; and
wherein upon unzipping the second zipper mechanism, the second zippered panel is openable allowing access to the bed of the truck.

2. The truck cover apparatus of claim 1 wherein the cover completely covers the cab and the bed of the truck.

3. The truck cover apparatus of claim 2 wherein the cover is free from extending all the way to a ground surface.

4. The truck cover apparatus of claim 2 wherein the cover extends all the way to a ground surface.

5. The truck cover apparatus of claim 1 wherein the first zippered panel of the cover is positionable over the driver's door of the truck.

6. The truck cover apparatus of claim 1 and further comprising:
two or more first zippered panels, each first zippered panel positionable over a door of the truck.

7. The truck cover apparatus of claim 1 and further comprising:
a third zippered panel formed in the cover, the third zippered panel capable of being positioned over the tailgate of the bed of the truck;
a third zipper mechanism associated with the third zippered panel;
wherein upon unzipping the third zipper mechanism, the third zippered panel is openable so that the tailgate can be opened allowing access to the bed of the truck.

8. The truck cover apparatus of claim 1 wherein the cover is constructed in various sizes corresponding to full sized pickups, short bed pickups, and compact pickups.

9. The truck cover apparatus of claim 1 wherein the cover is constructed from a high denier, synthetic polyester softly lined and smooth on an inside surface and waterproof, UV resistant, and mildew resistant on an outside surface.

10. The truck cover apparatus of claim 1 wherein the cover has a camouflage pattern imprint on an outside surface of the cover.

11. The truck cover apparatus of claim 10 wherein the camouflage pattern of the cover is a standard camouflage pattern or a specific camouflage pattern to tree stand hunters, brush country hunters, bottomland hunters, or waterfowl hunters.

12. The truck cover apparatus of claim 10 wherein the cover provides a line of formfitting, full length, all weather pickup covers that conceal and camouflage the truck to look similar to woods.

13. The truck cover apparatus of claim 1 and further comprising:
a drawstring carry bag for receiving the cover.

14. A method for covering a pickup truck, the pickup truck having a cab and a bed, the cab having at least a driver's side door and a passenger door, the bed having a tailgate, the method comprising:
providing a cover;
forming a first zippered panel formed in the cover;
positioning the first zippered panel over a door of the cab of the truck;
forming a second zippered panel formed in the cover;
positioning the second zippered panel over the bed of the truck;
associating a first zipper mechanism with the first zippered panel;
associating a second zipper mechanism with the second zippered panel;
unzipping the first zipper mechanism;
opening the first zippered panel;
allowing access to the cab of the truck;
unzipping the second zipper mechanism;
opening the second zippered panel; and
allowing access to the bed of the truck.

15. A truck cover apparatus for covering a pickup truck, the pickup truck having a cab and a bed, the cab having at least a driver's side door and a passenger door, the bed having a tailgate, the truck cover apparatus comprising:
a cover capable of completely covering the cab and the bed of the truck;
a first zippered panel formed in the cover, the first zippered panel capable of being positioned over a door of the cab of the truck;
a second zippered panel formed in the cover, the second zippered panel capable of being positioned over the bed of the truck;
a third zippered panel formed in the cover, the third zippered panel capable of being positioned over the tailgate of the bed of the truck;
a first zipper mechanism associated with the first zippered panel;
a second zipper mechanism associated with the second zippered panel; and
a third zipper mechanism associated with the third zippered panel;
wherein upon unzipping the first zipper mechanism, the first zippered panel is openable so that the door of the cab can be opened allowing access to the cab of the truck;
wherein upon unzipping the second zipper mechanism, the second zippered panel is openable allowing access to the bed of the truck; and
wherein upon unzipping the third zipper mechanism, the third zippered panel is openable so that the tailgate can be opened allowing access to the bed of the truck.

16. The truck′cover apparatus of claim 15 wherein the first zippered panel of the cover is positionable over the driver's door of the truck.

17. The truck cover apparatus of claim 15 and further comprising:
two or more first zippered panels, each first zippered panel positionable over a door of the truck.

18. The truck cover apparatus of claim 15 wherein the cover is constructed from a high denier, synthetic polyester softly lined and smooth on an inside surface and waterproof, UV resistant, and mildew resistant on an outside surface.

19. The truck cover, apparatus of claim 15 wherein the cover has a camouflage pattern imprint on an outside surface of the cover providing a line of formfitting, full length, all weather pickup covers that conceal and camouflage the truck to look similar to woods.

20. The truck cover apparatus of claim 15 and further comprising:
a drawstring carry bag for receiving the cover.
